(19) United States
(12) Patent Application Publication
(10) Pub. No.: US 2025/0299369 A1
(43) Pub. Date: Sep. 25, 2025

(54) SAFETY DECOMPOSITION USING REDUNDANT FIELD OF VIEW OF MULTIPLE SENSORS

(71) Applicant: Torc Robotics, Inc., Blacksburg, VA (US)

(72) Inventors: Martin Stoffel, Blacksburg, VA (US); Shubham Gupta, Blacksburg, VA (US)

(21) Appl. No.: 18/614,287

(22) Filed: Mar. 22, 2024

(51) Int. Cl. G06T 7/80; G01S 7/40; G01S 7/497; G06T 7/593

(52) U.S. Cl. CPC G06T 7/85; G01S 7/4004; G01S 7/497; G06T 7/593; G06T 2207/10012; G06T 2207/30256

(57) ABSTRACT

A perception system includes a first electronic control unit (ECU) coupled to a first image sensor and a second ECU coupled to a second image sensor. The first ECU and the second ECU are configured to perform feature detection for calibration using first calibration image data captured by the first image sensor of a first field of view and second calibration image data captured by the second image sensor of a second field of view. The first and second ECUs are further configured to (i) identify a set of pixels in a respective field of view having common features with another set of pixels in another field of view; (ii) receive image data from respective image sensor; (iii) reduce the image data to only a set of pixels in the respective field of view; and (iv) perform object detection on the respective image data consisting of the set of pixels.

### TECHNICAL FIELD

The field of the disclosure relates to vehicle safety and regulatory compliance and, in particular, to a method and a system for meeting a specific automotive safety integrity level using a redundant field of view of multiple sensors.

### BACKGROUND

Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies process features in the sensed environment to correlate, or register, those features to known features on a map. Localization technologies may rely on inertial navigation system (INS) data. Behaviors and planning technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. This includes steering, braking and acceleration.

Perception technologies generally uses sensors like a camera, a radio detection and ranging (RADAR) sensor, a light detection and ranging (LiDAR) sensor for detecting the surrounding environment of the autonomous vehicle. Redundant sensors generally improve the integrity and reliability of the perception system; however, because the multiple sensors typically have different fields of view, true redundancy for the end-to-end perception system cannot be achieved.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

In one aspect, a perception system including a first image sensor, a second image sensor, a first electronic control unit (ECU) coupled to the first image sensor, and a second ECU coupled to the second image sensor is disclosed. The first image sensor is configured to capture first calibration image data in a first field of view, and subsequently capture first image data in the first field of view. The second image sensor is configured to capture second calibration image data in a second field of view, and subsequently capture second image data in the second field of view. The first ECU and the second ECU each includes at least one memory configured to store machine executable instructions and at least one processor configured to execute the stored executable instructions. Each of the first ECU and the second ECU is configured to receive the first calibration image data and the second calibration image data and perform feature detection for calibration using the first calibration image data and the second calibration image data. The first ECU is further configured to: (i) identify a first set of pixels in the first field of view having common features with a second set of pixels in the second field of view; (ii) receive the first image data from the first image sensor; (iii) reduce the first image data to only the first set of pixels in the first field of view; and (iv) perform object detection on the first image data consisting of the first set of pixels. The second ECU is further configured to: (i) identify the second set of pixels in the second field of view having the common features with the first set of pixels in the first field of view; (ii) receive the second image data from the second image sensor; (iii) reduce the second image data to only the second set of pixels in the second field of view; and (iv) perform object detection on the second image data consisting of the second set of pixels.

In another aspect, a computer-implemented method performed by a first electronic control unit (ECU) and a second ECU of a perception system of a vehicle is disclosed. The computer-implemented method includes: (i) receiving, at the first ECU and the second ECU, first calibration image data in a first field of view and a second calibration image data in a second field of view, the first calibration image data captured by a first image sensor and the second calibration image data captured by a second image sensor; (ii) performing, by the first ECU and the second ECU, object detection for calibration using the first calibration image data and the second calibration image data; (iii) identifying, by the first ECU, based upon the first calibration image data and the second calibration image data, a first set of pixels in the first field of view having common features with a second set of pixels in the second field of view; (iv) identifying, by the second ECU, based upon the first calibration image data and the second calibration image data, the second set of pixels in the second field of view having the common features with the first set of pixels in the first field of view; (v) receiving, at the first ECU, first image data from the first image sensor; (vi) receiving, at the second ECU, second image data from the second image sensor; (vii) reducing, by the first ECU, the first image data to only the first set of pixels in the first field of view; (viii) reducing, by the second ECU, the second image data to only the second set of pixels in the second field of view; (ix) performing, by the first ECU, object detection on the first image data consisting of the first set of pixels; and (x) performing, by the second ECU, object detection on the second image data consisting of the second set of pixels.

In yet another aspect, a vehicle is disclosed. The vehicle includes a first image sensor, a second image sensor, a first electronic control unit (ECU) coupled to the first image sensor, and a second ECU coupled to the second image sensor is disclosed. The first image sensor is configured to capture first calibration image data in a first field of view, and subsequently capture first image data in the first field of view. The second image sensor is configured to capture second calibration image data in a second field of view, and subsequently capture second image data in the second field of view. The first ECU and the second ECU each includes at least one memory configured to store machine executable instructions and at least one processor configured to execute the stored executable instructions. Each of the first ECU and the second ECU is configured to receive the first calibration image data and the second calibration image data and perform feature detection for calibration using the first calibration image data and the second calibration image data. The first ECU is further configured to: (i) identify a first set of pixels in the first field of view having common features with a second set of pixels in the second field of view; (ii) receive the first image data from the first image sensor; (iii) reduce the first image data to only the first set of pixels in the first field of view; and (iv) perform object detection on the first image data consisting of the first set of pixels. The second ECU is further configured to: (i) identify the second set of pixels in the second field of view having the common features with the first set of pixels in the first field of view; (ii) receive the second image data from the second image sensor; (iii) reduce the second image data to only the second set of pixels in the second field of view; and (iv) perform object detection on the second image data consisting of the second set of pixels.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic view of an autonomous truck;

FIG. 2 is a block diagram of the autonomous truck shown in FIG. 1;

FIG. 3 is a block diagram of an example computing system;

FIG. 4A is a block diagram of an embodiment of a redundant perception system;

FIG. 4B is a block diagram of an embodiment of redundant lane detection system using dual image cropping;

FIG. 5 is a block diagram of an example computing device; and

FIG. 6 is a flow-chart of method operations performed by the perception system shown in FIG. 4A or FIG. 4B.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure. The following terms are used in the present disclosure as defined below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

Conventionally, identical data for processing by redundant machine-learning algorithm systems may be received using a camera and a signal splitter such that an image from the camera is routed to the two electronic control units (ECUs), or image signal processors, with the same object detection machine-learning algorithm. However, the camera and the signal splitter are single points of failure. The disclosed systems and methods achieve redundancy for safety critical applications with redundant fields of view from multiple sensors, such as cameras or LiDAR sensors.

For redundant safety critical systems applications, the disclosed systems and methods perform object detection based upon the exact same images available as input to machine-learning algorithms also being operating redundantly such that the exact same output results from each of the redundant hardware and software systems. In some embodiments, to avoid the single point of failure on the camera side, two cameras may be used. Both the cameras may be mounted, or positioned, on a vehicle to observe the same scene without having the exact same image due to each camera having a different but overlapping field of view. An algorithm, a library, or a driver may process the images captured by both cameras to identify an overlapping region of both images. The algorithm, library, or driver may be calibrated initially or multiple times during operation to identify a region that is an overlapping region in each image received by the algorithm, library, or driver for detecting one or more objects in the image. Accordingly, each algorithm, library, or driver operating on two separate ECUs have the exact same image data corresponding to the overlapping region even though they are not captured from a single camera. The image data corresponding to the overlapping region then may be used for detecting one or more objects using object detection algorithms operating on two separate ECUs. An output from an object detection algorithm operating on a first ECU may be compared with an output from another object detection algorithm operating on a second ECU using a respective voter on each redundant ECUs. In the event of matching results of the voters, an automotive safety integrity level (ASIL) decomposition principle may be fulfilled. Additionally, the system using two cameras as described herein may be in compliance to eliminate random hardware faults and for providing high availability pursuant to ISO26262.

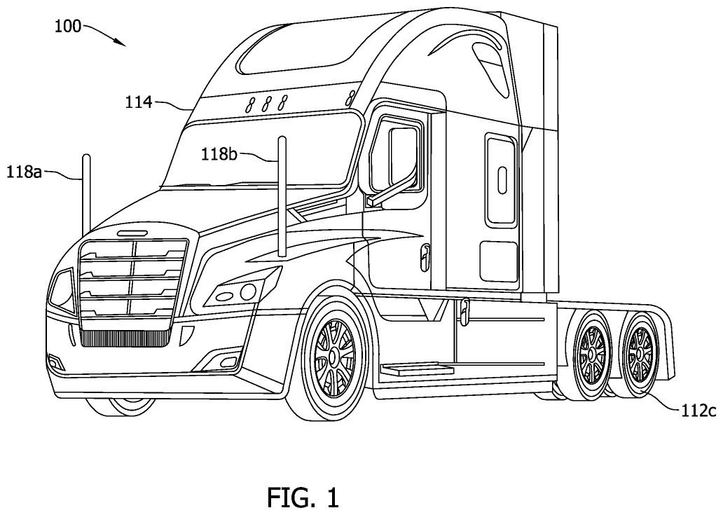

Various embodiments in the present disclosure are described with reference to FIGS. 1-4 below. Further, even though the embodiments are described for perception technologies used in autonomous vehicles, the embodiments described herein do not limit their scope to autonomous vehicles only and may be embodied in non-autonomous vehicles or semi-autonomous vehicles as well.

FIG. 1 illustrates a vehicle 100, such as a truck that may be conventionally connected to a single or tandem trailer to transport the trailers (not shown) to a desired location. The vehicle 100 includes a cabin 114 that can be supported by, and steered in the required direction, by front wheels 112a, 112b, and rear wheels 112c that are partially shown in FIG. 1. Wheels 112a, 112b are positioned by a steering system that includes a steering wheel and a steering column (not shown in FIG. 1). The steering wheel and the steering column may be located in the interior of cabin 114.

The vehicle 100 may be an autonomous vehicle, in which case the vehicle 100 may omit the steering wheel and the steering column to steer the vehicle 100. Rather, the vehicle 100 may be operated by an autonomy computing system (not shown) of the vehicle 100 based on data collected by a sensor network (not shown in FIG. 1) including one or more sensors.

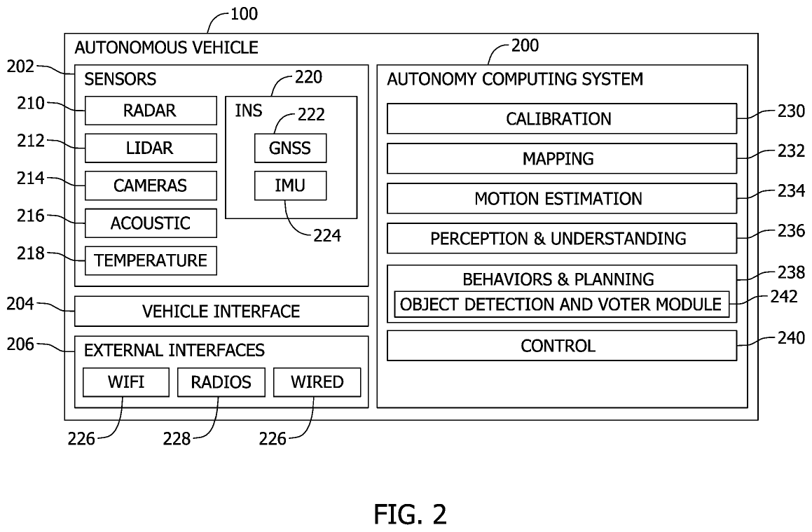

FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 120 to determine how to control operation of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be stitched or combined to generate a visual representation of the multiple cameras' FOVs, which may be used to, for example, generate a bird's eye view of the environment surrounding autonomous vehicle 100. In some embodiments, the image data generated by cameras 214 may be sent to autonomy computing system 200 or other aspects of autonomous vehicle 100, and this image data may include autonomous vehicle 100 or a generated representation of autonomous vehicle 100. In some embodiments, one or more systems or components of autonomy computing system 200 may overlay labels to the features depicted in the image data, such as on a raster layer or other semantic layer of a high-definition (HD) map.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. Radar sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw radar sensor data) from the emitted radio waves. In some embodiments, the system inputs from cameras 214, radar sensors 210, or LiDAR sensors 212 may be fused or used in combination to determine conditions (e.g., locations of other objects) around autonomous vehicle 100.

GNSS receiver 222 is positioned on autonomous vehicle 100 and may be configured to determine a location of autonomous vehicle 100, which it may embody as GNSS data, as described herein. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, and or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connection while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a control module or controller 240, and an object detection and voter module 242. The object detection and voter module 242, for example, may be embodied within another module, such as behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

The object detection and voter module 242 may help maintaining proper lane position for autonomous vehicle 100 in all conditions, e.g., regardless of signage for given road conditions. object detection and voter module 242 receives, for example, positions of left or right lane markings from perception and understanding module 236 and computes a lane position offset from the identified lane marking. Where both left and right lane markings are detected by perceptions and understanding module 236, in combination with sensors 202, object detection and voter module 242 selects one lane marking from which lane positioning is derived.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

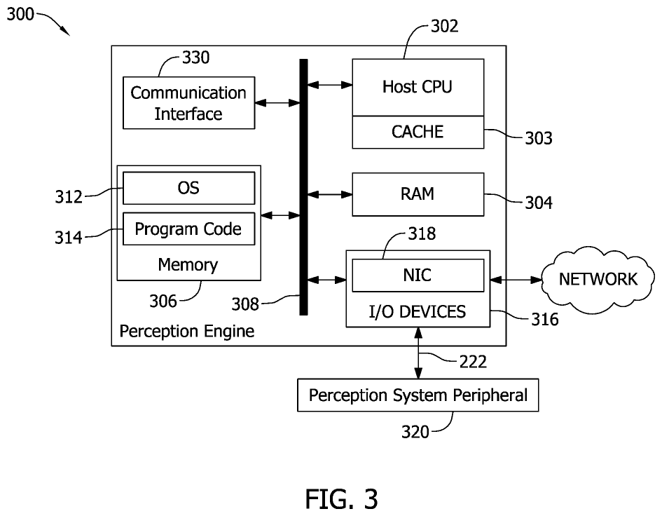

FIG. 3 is a block diagram of an example computing system 300, such as the autonomy computing system 200 shown in FIG. 2, configured for sensing an environment in which an autonomous vehicle is positioned. Computing system 300 includes a CPU 302 coupled to a cache memory 303, and further coupled to RAM 304 and memory 306 via a memory bus 308. Cache memory 303 and RAM 304 are configured to operate in combination with CPU 302. Memory 306 is a computer-readable memory (e.g., volatile, or non-volatile) that includes at least a memory section storing an OS 312 and a section storing program code 314. Program code 314 may be one of the modules in the autonomy computing system 200 shown in FIG. 2. In alternative embodiments, one or more section of memory 306 may be omitted and the data stored remotely. For example, in certain embodiments, program code 314 may be stored remotely on a server or mass-storage device and made available over a network 332 to CPU 302.

Computing system 300 also includes I/O devices 316, which may include, for example, a communication interface such as a network interface controller (NIC) 318, or a peripheral interface for communicating with a perception system peripheral device 320 over a peripheral link 322. I/O devices 316 may include, for example, a GPU for image signal processing, a serial channel controller or other suitable interface for controlling a sensor peripheral such as one or more acoustic sensors, one or more LiDAR sensors, one or more cameras, or a CAN bus controller for communicating over a CAN bus.

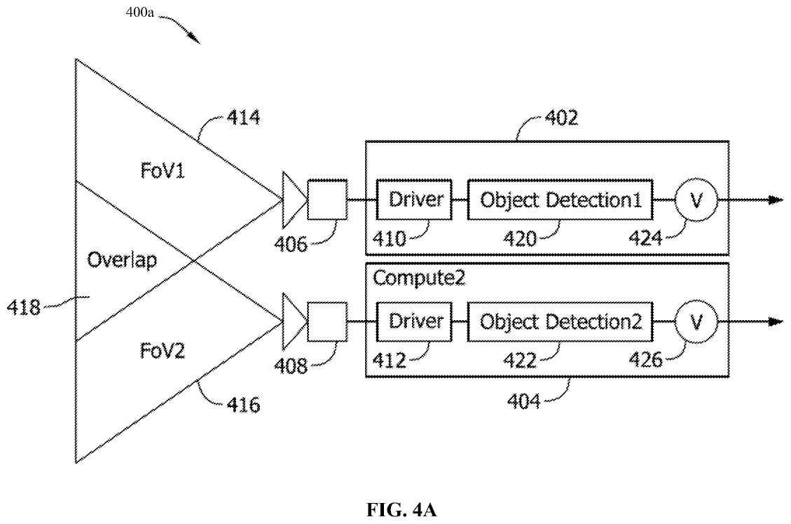

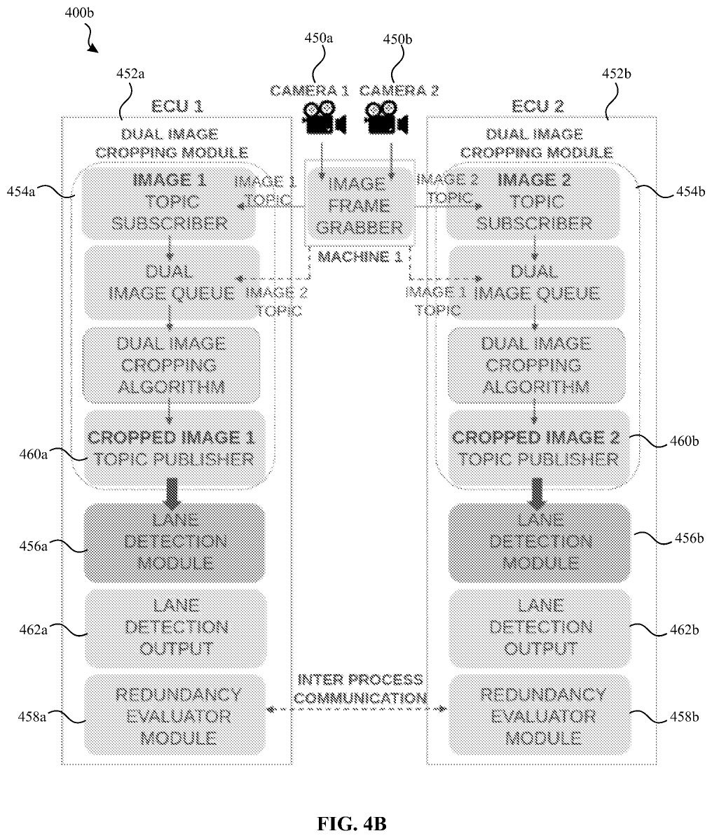

FIG. 4A is a schematic block diagram 400a of a redundant perception system, which may be embodied, for example, in a computing system such as computing system 300 shown in FIG. 3, executing a perception and understanding module 236 shown in FIGS. 2-3. Referring to FIG. 4, a first ECU 402 and a second ECU 404 are redundant and intended to produce a matching output from redundant object detection processes. The first ECU 402 and the second ECU 404 may be similar to a computing system 300 shown in FIG. 3. The first ECU 402 and the second ECU 404 may be configured to receive data from a first camera 406 and a second camera 408, respectively. Additionally, or alternatively, LiDAR sensors may also be used in place of, or along with, cameras 406 and 408. The first ECU 402 and the second ECU 404 may also receive data from the first camera 406 and the second camera 408 while calibrating positioning of the first camera 406 and the second camera 408 and calibrating a first driver 410 and a second driver 412 configured to identify an overlapping region of a first image captured using the first camera 406 and a second image captured using the second camera 408. By way of a non-limiting example, the first driver 410 or the second driver 412 may be an algorithm or a library. In some embodiments, and by way of a non-limiting example, the first 410 and the second driver 412 may be perception and understanding module 236 shown in FIG. 2. The first driver 410 and the second driver 412 may be operating on the first ECU 402 and the second ECU 404, respectively. The first camera 406 and the second camera 408 may be mounted, or positioned, on the vehicle to look, for example, in the forward direction. The first camera 406 and the second camera 408 may be mounted, or positioned, on the vehicle such that they have an overlapping field of view (FOV). The first camera 406 has a field of view (FOV) 414, and the second camera 408 has a FOV 416. As shown in FIG. 4, the FOV 414 and the FOV 416 overlap with each other in an overlapping region 418.

In some embodiments, and by way of a non-limiting examples, the first camera 406 and the second camera 408 may have a size of the respective camera sensor or a magnification configured to observe an entire driving lane in which the vehicle is currently positioned in the overlapping region 318 from a specific distance (e.g., 3 meter or 4 meter) in the forward looking direction from the vehicle. The overlapping region 418 thus includes image data of the entire driving lane that may include markers identifying the driving lane (e.g., two solid or broken white lanes, a solid yellow line on one side and a solid or a broken white lane, a solid white line on one side and a solid or a broken white lane, etc.). The markers identifying the driving lane at equal distances, or almost equal distances, from a left edge and a right edge in the overlapping region may suggest that the vehicle is in a center of the driving lane. Absence of both markers identifying a driving lane, or different distances from the left edge and the right edge for both markers identifying the driving lane, may suggest the vehicle is not positioned in the center of the driving lane. Additionally, or alternatively, other objects such as other vehicles, road signs, debris, structures, etc., in the overlapping region 418 may be detected and processed by an object detection module of each ECU as described below.

Accordingly, in some embodiments, during initialization of the perception system, the first and second cameras 406 and 408 and the first and second drivers 410 and 412 may be calibrated to identify the overlapping region 418 of the captured images of the FOV 414 and the FOV 416. The calibration to identify the overlapping region 418 may be performed using one or more algorithms including, but not limited to, a deep neural network (DNN) based algorithm, scale invariant feature transform (SIFT) algorithm, etc. Based on the identified overlapping region 418 of the FOV 414 and the FOV 416, data of images taken by both of the first camera 406 and the second camera 408 are not continuously required to be processed by the first driver 410 and the second driver 412 both during runtime.

Over time, for example, due to vibrations caused by movement of the vehicle, the FOV 414 of the first camera 406 and the FOV 416 of the second camera 408 may change and the calibration process may be repeated to recalibrate and identify the overlapping region 418, as described herein. In certain embodiments, recalibration may be performed as required or periodically based on, for example, time or miles travelled.

The first ECU 402 includes an object detection module 420 and the second ECU 404 includes a redundant object detection module 422. Object detection modules 420 and 422 may be embodied, for example, in a hardware or software implemented image signal processor (ISP). For example, object detection modules 420 and 422 may be embodied in one or more sections of program code stored locally or remotely in memory as executable instructions for one or more processors of the first ECU 402 and the second ECU 404, such as processors or CPU 302 shown in FIG. 3. Alternatively, object detection modules 420 and 422 may be embodied in a hardware ISP including one or more ASICs, DSPs, or other processing devices. Object detection modules 420 and 422 may be embodied in a combination of hardware and software. Object detection modules 420 and 422 both operate on only overlapping region 418.

An output generated by each of the first object detection algorithm 420 and the second object detection algorithm 422 is processed by a first voter 424 and a second voter 426. By way of a non-limiting example, each of the first voter 424 and the second voter 426 may receive the output generated by each of the first object detection algorithm 420 and the second object detection algorithm 422 via a bus, e.g., a system bus or a controller area network (CAN) bus. The system bus or CAN bus may also connect the first driver 410 to receive data from each of the first camera 406 and the second camera 408. Similarly, the system bus or CAN bus may also connect the second driver 412 to receive data from each of the first camera 406 and the second camera 408. In some embodiments, the first object detection algorithm 420 and the second object detection algorithm 422 may generate a list of detected objects and their positions in the overlapping region 418. When each of the first voter 424 and the second voter 426 determines the output generated by each of the first object detection algorithm 430 and the second object detection algorithm 422 are identical, or in other words the detected objects and their positions in the generated lists are identical, first voter 424 and second 4oter 326 confirm there is no physical (or mechanical) or software problem, failure, or other fault in the hardware and software modules of the perception system 236. However, when either of the first voter 424 and the second voter 426 determines that the output generated by each of the first object detection algorithm 420 and the second object detection algorithm 422 are not identical, the first voter 424 or the second voter 426 indicates a physical (or mechanical) or software problem, failure, or another fault exists in the hardware and software modules of the perception system requiring calibration of the perception system 400 or limiting functionality of the autonomous vehicle 100. An output of the first voter 424 and an output of the second voter 426 may indicate whether the output generated by each of the first object detection algorithm 420 and the second object detection algorithm 422 is identical or not identical and may be provided to a downstream user of the perception system 400, such as behaviors and planning module 238. By way of a non-limiting example, the first voter 424 and the second voter 426 each may set a value of a Boolean field to True (1) as long as the first voter 424 and the second voter 426 confirm that the output generated by the first object detection algorithm 420 is identical to the output generated by the second object detection algorithm 422. Accordingly, when the first voter 424 or the second voter 426 sets the value of the Boolean field to False (0), the behaviors and planning module 238 may take an action according to the physical (or mechanical) or software problem, failure, or another fault in the hardware and software modules of the perception system.

In some embodiments, and by way of a non-limiting example, calibration of the perception system may be performed periodically based on time or based on distance driven by the vehicle.

FIG. 4B is a block diagram 400b of an embodiment of redundant lane detection system using dual image cropping. The block diagram 400b may represent an architecture of the redundant lane detection system using a dual image cropping algorithm. Image frames of the two cameras 450a and 450b may be deployed on a computing device including an image frame grabber to which the cameras may have been attached. The computing device may include ECU1 452a and ECU2 452b communicatively coupled with each other, for example, using a 1 Gbit Ethernet switch (not shown in FIG. 4B). Software wise, each of the ECU1 452a and ECU2 452b may include at least a dual image cropping module 454a/454b, a lane detection module 456a/456b, and a redundancy evaluator module 458a/458b.

In some embodiments, the dual image cropping module 454 may include various algorithms from stereo calibration, image rectification to image cropping and publishing the cropped image based on the camera value parameter. The lane detection module 456 may be a neural network-based lane detection module, which takes a cropped image 460a/460b as an input and computes a lane detection output 462a/462b. The lane detection output 462a/462b may include a distance to a left lane marking and a distance to a right lane marking. The redundancy evaluator module 458 may include a distributed voter algorithm, as described herein, and configured to share the calculation result of each iteration across both the ECUs 452a and 452b for comparing redundantly.

In some embodiments, and by way of a non-limiting example, the dual image cropping module 454 may include algorithms based on stereo vision technology and image processing in order to achieve sensor data redundancy. The process extracts the overlapping region of each FOV between the left image and the right image in a parallel vision stereo setup and crops out the non-overlapping region so that only the region of interest (RoI) remains for further analysis or processing. The result of this process is two very similar images which come out of two different cameras 450a and 450b, also described herein with respect to FIG. 4A. Those independent sources are necessary to fulfil the ASIL decomposition principle.

In some embodiments, the algorithm's execution may be divided into four major steps where the first three steps including a subscription phase, a rectification phase, and a disparity calculation phase are used to find the overlaps between the images, and the fourth step of iterative cropping and publishing phase is the continuous execution of the algorithm, therefore being executed multiple times in an iterative manner to crop each frame. Each phase of the algorithm's execution is described in detail below.

In some embodiment, the subscription phase corresponds with subscribing to images captured using two cameras 450a and 450b, in which the image subscription of one or more images from camara 450a in ECU1 452a is considered primary image subscription and image subscription of one or more images from camera 450b in ECU2 452b is considered temporary image subscription, and vice-versa until the disparity calculation phase is completed. Each image frame is stored in two buffers in order to compare if the time difference between the frames is within 0.05 milliseconds. If not, the images are removed from the buffer to adjust for time synchronization to the nearest value.

In some embodiment, the rectification phase corresponds with retrieval of time synchronized images from their respective buffers and their conversion into, for example, an OpenCV image type. The intrinsic and extrinsic camera calibration parameters

are extracted from the image topics. Then stereo calibration parameters, e.g., rotation matrix and translation vector from a first camera plane to a second camera plane, are calculated. The stereo and calibration parameters are used to calculate rectification transform (rotation matrix) and projection matrix in the new (rectified) coordinate systems for the camera. The stereo and calibration parameters in the new coordinate system are then saved.

In some embodiment, during the disparity calculation phase, the images are rectified. In other words, displacement of an object in an image from camera 450a and in an image from camera 450b is restricted to only horizontal direction using rectification parameters from the rectification phase and then feature detection and description for each image is done using an ORB algorithm for matching key points of the image from camera 450a with description with other key points of the image from camera 450b with description. In some embodiments, and by way of a non-limiting example, key points may be matched using Brute Force Feature Matching algorithm, and matching key points are then stored. Subsequently, any outliers may be removed from the matches. Two different techniques may be employed to filter the outliers. The first technique may use distance threshold between the matches as described in the ORB algorithm, and the second technique may use calculating a slope between pixel points of the matched key points of an image captured using camera 450a and an image captured using camera 450b, and filtering the key points whose slope is not equal to 0. The second outlier filtering method is based on the hypothesis that the images are rectified, and camera setup is a parallel vision setup so the slope of the matched points must be 0. After that good matches are searched for left-most point in the image captured using camera 450a and the right-most point in the image captured using camera 450b out of the matches in order to find the disparity, or in other words, the horizontal displacement of the key points from the image captured using camera 450a to the image captured using camera 450b. The reason for selection of these points is due to the fact that disparity of each matched point will be different and decreases from a point that are closer to the camera to the points that are farther from the camera. As the image from camera 450a mounted on the left of camera 450b, the cropped out area may also be in the left side which will be nonoverlapping from the image captured by camera 450b, and vice versa. For both these points, the displacement may be calculated by difference of the horizontal pixel coordinate of matched point of the image from camera 450a from the image from camera 450a, and the maximum displacement may be taken as the cropped width for the cropping area and saved as a cropping parameter.

In some embodiments, the iterative cropping and publishing phase is performed after both rectification and cropping parameters are saved. Based on camera name parameter in the ECU for example in ECU1 452a, ‘CAMERA 1’ and for ECU2 452b, ‘CAMERA 2’ is given as the camera name parameter in the robot operating system-2 (ROS2) nodes. Based on the camera name, the process may repeat in the iterative manner which includes taking the raw image directly from the image buffer of the specified camera and converts into the OpenCV image type and then rectify the image and then crop out the image using cropping area in cropping parameter and then reconvert the image to ROS2 image type and publish it as a cropped image. For an image captured using camera 452a, the left side of the image is cropped, and for an image captured using camera 452b, the right side of the image is cropped and then published, respectively.

By way of a non-limiting example, cameras 450a and 450b may be identical Leopard Imaging Automotive Camera placed on the vehicle 100 at a baseline distance of 250 cm in a near perfect parallel binocular stereo vision setup such that the cameras 450a and 450b are horizontally apart from each other at a distance of 250 cm but vertically on a same plane, and thereby ensuring the displacement in the images of the camera 450a and 450b is restricted almost to a horizontal direction. Alternatively, cameras 450a and 450b may be mounted very close to each other at the center of the vehicle 100 with a baseline distance of 2 cm in a near perfect parallel binocular stereo vision setup. ECU1 452a and ECU2 452b may be state-of-the-art NVIDIA DRIVE AGX ORIN automotive ECUs installed in the vehicle 100, which may be time synchronized using Precision Time Protocol (PTP). The architecture block diagram 400b of the redundant lane detection system using dual image cropping thus extends redundancy to the cameras 450a and 450b, and thereby building up two logical fully independent channels.

In some embodiments, for the two different camera setups described herein with an update rate of 3 Hz, it is observed that safety of an autonomous driving system may be significantly improved by using the dual image cropping algorithm described herein for the camera setup having a short distance (e.g., 2 cm) between them in comparison to the camera setup having a large distance (e.g. 250 cm) between them. The redundant lane detection system, as described herein, may be further improved to minimize the errors by two counter measures. The first counter measure may include adjusting to minimize the stereo vision correspondence for each iteration rather than only cropping out the overlapping area of each image. The second counter measure may be to optimizing the time synchronization of the two cameras 450a and 450b in order to maximize the similarity of the images taken by cameras 450a and 450b.

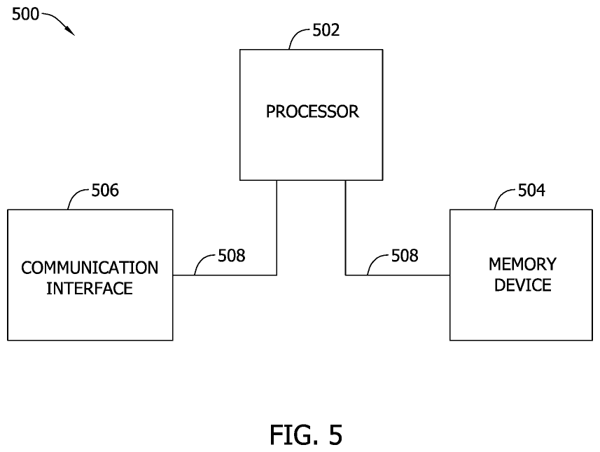

FIG. 5 is a block diagram of an example computing device 500. Computing device 500 includes a processor 502 and a memory device 504. The processor 502 is coupled to the memory device 504 via a system bus 508. The term “processor” refers generally to any programmable system including systems and microcontrollers, reduced instruction set computers (RISC), complex instruction set computers (CISC), application specific integrated circuits (ASIC), programmable logic circuits (PLC), and any other circuit or processor capable of executing the functions described herein. The above examples are example only, and thus are not intended to limit in any way the definition or meaning of the term “processor.”

In the example embodiment, the memory device 504 includes one or more devices that enable information, such as executable instructions or other data (e.g., sensor data), to be stored and retrieved. Moreover, the memory device 504 includes one or more computer readable media, such as, without limitation, dynamic random access memory (DRAM), static random access memory (SRAM), a solid state disk, or a hard disk. In the example embodiment, the memory device 504 stores, without limitation, application source code, application object code, configuration data, additional input events, application states, assertion statements, validation results, or any other type of data. The computing device 500, in the example embodiment, may also include a communication interface 506 that is coupled to the processor 502 via system bus 508. Moreover, the communication interface 506 is communicatively coupled to data acquisition devices.

In the example embodiment, processor 502 may be programmed by encoding an operation using one or more executable instructions and providing the executable instructions in the memory device 504. In the example embodiment, the processor 502 is programmed to select a plurality of measurements that are received from data acquisition devices.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

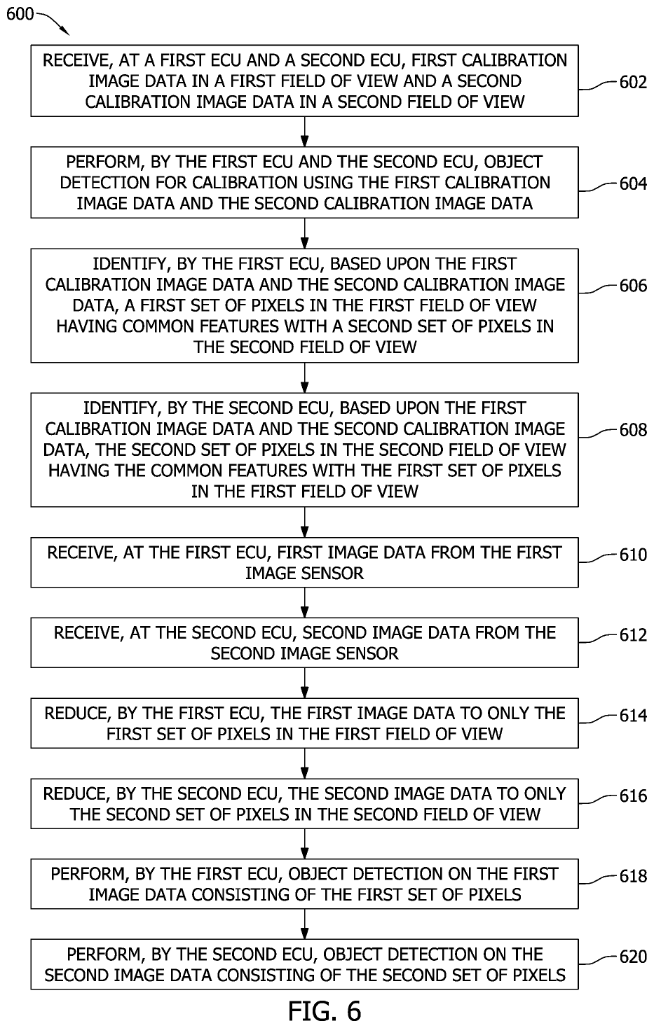

FIG. 6 is an example flow-chart 600 of method operations performed by the perception system shown in FIG. 4A or FIG. 4B. The method operations shown in the flow-chart 600 may be performed by the perception system of a vehicle, and the perception system may include a first image sensor, a second image sensor, a first ECU coupled with the first image sensor, and a second ECU coupled with the second image sensor. The first ECU may be coupled with the first image sensor using a system bus (e.g., a CAN bus), and the second ECU may be coupled with the second image sensor using the system bus. Additionally, the first ECU and the second ECU may be coupled with the second image sensor and the first image sensor, respectively, via the system bus. The method operations may include receiving 602 first calibration image data in a first field of view and a second calibration image data in a second field of view at both the first ECU and the second ECU. The first calibration image data may be captured by the first image sensor and the second calibration image data may be captured by the second image sensor. By way of a non-limiting example, the first image sensor and the second image sensor may be camera sensors, RADAR sensors, or LiDAR sensors.

The method operations may further include performing 604 object detection for calibration using the first calibration image data and the second calibration image data by both of the first ECU and the second ECU. The object detection for calibration includes identifying a list of objects and their respective locations by each of the first ECU and the second ECU in the first calibration image data and the second calibration image data. The list of objects may be identified using artificial intelligence models, such as convolutional neural networks (CNNs). Based upon the identified list of objects and their respective locations (or positions) in the first calibration image data and the second calibration image data being same, the perception system including the first image sensor and the second image sensor may be considered to be calibrated to provide perception services in a redundant mode. After the perception system is calibrated, the first ECU may not need to receive image data from the second image sensor and the second ECU may not need to receive image date from the first image sensor, unless calibration is required again, as described herein.

The method operations may further include identifying 606, based upon the first calibration image data and the second calibration image data by the first ECU, a first set of pixels in the first field of view having common features with a second set of pixels in the second field of view. The second set of pixels in the second field of view corresponds with the second calibration image data. The method operations may further include identifying 608, based upon the first calibration image data and the second calibration image data by the second ECU, the second set of pixels in the second field of view having the common features with the first set of pixels in the first field of view. The first set of pixels in the first field of view corresponds with the first calibration image data. The first set of pixels and the second set of pixels having common features thus corresponds with an overlapping region of the first field of view of the first image sensor and the second field of view of the second image sensor. The first set of pixels and the second set of pixels corresponding the overlapping region may thus present identical image data (or true redundant image data) for processing by the first ECU and the second ECU.

The method operations may include receiving 610 first image data from the first image sensor at the first ECU and receiving 612 second image data from the first image sensor at the second ECU. The first image data may correspond with the first field of view of the first sensor and the second image data may correspond with the second field of view of the second sensor. Additionally, the first field of view may be different from the second field of view. Accordingly, the method operations may include reducing 614 the first image data to only the first set of pixels in the first field of view by the first ECU and reducing 616 the second image data to only the second set of pixels in the second field of view by the second ECU. Reducing the first image data to the first set of pixels by the first ECU and the second image data to the second set of pixels by the second ECU thus generates identical data for performing 618 object detection on the first image data consisting of the first set of pixels by the first ECU and performing 620 object detection on the second image data consisting of the second set of pixels by the second ECU. Since the first set of pixels and the second set of pixels corresponds with the overlapping region of the first field of view and the second field of view, object detection performed 618 by the first ECU matches with object detection performed 620 by the second ECU. However, when object detection performed 618 by the first ECU does not match with object detection performed 620 by the second ECU, the perception system may be calibrated again by re-identifying the first set of pixels in the first field of view having common features with the second set of pixels in the second field of view. The first set of pixels and the second set of pixels may include one or more lane identification markers, or other objects.

An example technical effect of the methods, systems, and apparatus described herein includes at least one of: (a) improvised ego-lane level localization corresponding to identifying the vehicle's position in a driving lane; and (b) achieving a true end-to-end redundant perception system including an object detection module, and one or more sensors.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A perception system, comprising:
a first image sensor configured to capture first calibration image data in a first field of view, and subsequently capture first image data in the first field of view;
a second image sensor configured to capture second calibration image data in a second field of view, and subsequently capture second image data in the second field of view;
a first electronic control unit (ECU) coupled to the first image sensor, the first ECU comprising at least one memory configured to store machine executable instructions and at least one processor configured to execute the stored executable instructions;
a second ECU coupled to the second image sensor, wherein the second ECU comprising at least one memory configured to store machine executable instructions and at least one processor configured to execute the stored machine executable instructions;
wherein each of the first ECU and the second ECU is configured to:
receive the first calibration image data and the second calibration image data; and
perform feature detection for calibration using the first calibration image data and the second calibration image data;
wherein the first ECU is further configured to:
identify a first set of pixels in the first field of view having common features with a second set of pixels in the second field of view;
receive the first image data from the first image sensor;
reduce the first image data to only the first set of pixels in the first field of view; and
perform object detection on the first image data consisting of the first set of pixels; and
wherein the second ECU is further configured to:
identify the second set of pixels in the second field of view having the common features with the first set of pixels in the first field of view;
receive the second image data from the second image sensor;
reduce the second image data to only the second set of pixels in the second field of view; and
perform object detection on the second image data consisting of the second set of pixels.

2. The perception system of claim 1, wherein the first image sensor and the second image sensor are camera sensors.

3. The perception system of claim 1, wherein the first image sensor and the second image sensor are radio detection and ranging (RADAR) sensors.

4. The perception system of claim 1, wherein the first image sensor and the second image sensor are light detection and ranging (LiDAR) sensors.

5. The perception system of claim 1, wherein the first ECU is further configured to verify the object detection performed using the first set of pixels matches with the object detection performed using the second set of pixels by the second ECU; and the second ECU is further configured to verify the object detection performed using the second set of pixels matches with the object detection performed using the first set of pixels by the first ECU.

6. The perception system of claim 5, wherein the instructions further cause each of the first ECU and the second ECU to upon the object detection performed using the first set of pixels not matching with the object detection performed using the second set of pixels by the second ECU, calibrate the perception system by re-identifying the first set of pixels in the first field of view having common features with the second set of pixels in the second field of view.

7. The perception system of claim 5, wherein the first set of pixels and the second set of pixels include one or more lane identification markers.

8. A computer-implemented method performed by a first electronic control unit (ECU) and a second ECU of a perception system of a vehicle, the method comprising:
receiving, at the first ECU and the second ECU, first calibration image data in a first field of view and a second calibration image data in a second field of view, the first calibration image data captured by a first image sensor and the second calibration image data captured by a second image sensor;
performing, by the first ECU and the second ECU, object detection for calibration using the first calibration image data and the second calibration image data;
identifying, by the first ECU, based upon the first calibration image data and the second calibration image data, a first set of pixels in the first field of view having common features with a second set of pixels in the second field of view;
identifying, by the second ECU, based upon the first calibration image data and the second calibration image data, the second set of pixels in the second field of view having the common features with the first set of pixels in the first field of view;
receiving, at the first ECU, first image data from the first image sensor;
receiving, at the second ECU, second image data from the second image sensor;
reducing, by the first ECU, the first image data to only the first set of pixels in the first field of view;
reducing, by the second ECU, the second image data to only the second set of pixels in the second field of view;
performing, by the first ECU, object detection on the first image data consisting of the first set of pixels; and
performing, by the second ECU, object detection on the second image data consisting of the second set of pixels.

9. The computer-implemented method of claim 8, wherein the first image sensor and the second image sensor are camera sensors.

10. The computer-implemented method of claim 8, wherein the first image sensor and the second image sensor are radio detection and ranging (RADAR) sensors.

11. The computer-implemented method of claim 8, wherein the first image sensor and the second image sensor are light detection and ranging (LiDAR) sensors.

12. The computer-implemented method of claim 11, further comprising verifying, by the first ECU, the object detection performed using the first set of pixels matches with the object detection performed by the second ECU using the second set of pixels; and verifying, by the second ECU, the object detection performed using the second set of pixels matches with the object detection performed by the first ECU using the first set of pixels.

13. The computer-implemented method of claim 12, further comprising, in response to the object detection performed by the first ECU using the first set of pixels not matching with the object detection performed by the second ECU using the second set of pixels, or vice versa, calibrating the perception system by re-identifying the first set of pixels in the first field of view having common features with the second set of pixels in the second field of view.

14. The computer-implemented method of claim 12, wherein the first set of pixels and the second set of pixels include one or more lane identification markers.

15. A vehicle, comprising:
a first image sensor configured to capture first calibration image data in a first field of view, and subsequently capture first image data in the first field of view;
a second image sensor configured to capture second calibration image data in a second field of view, and subsequently capture second image data in the second field of view;
a first electronic control unit (ECU) coupled to the first image sensor, the first ECU comprising at least one memory configured to store machine executable instructions and at least one processor configured to execute the stored executable instructions;
a second ECU coupled to the second image sensor, wherein the second ECU comprising at least one memory configured to store machine executable instructions and at least one processor configured to execute the stored machine executable instructions;
wherein each of the first ECU and the second ECU is configured to:
receive the first calibration image data and the second calibration image data; and
perform feature detection for calibration using the first calibration image data and the second calibration image data;
wherein the first ECU is further configured to:
identify a first set of pixels in the first field of view having common features with a second set of pixels in the second field of view;
receive the first image data from the first image sensor;
reduce the first image data to only the first set of pixels in the first field of view; and
perform object detection on the first image data consisting of the first set of pixels; and
wherein the second ECU is further configured to:
identify the second set of pixels in the second field of view having the common features with the first set of pixels in the first field of view;
receive the second image data from the second image sensor;
reduce the second image data to only the second set of pixels in the second field of view; and
perform object detection on the second image data consisting of the second set of pixels.

16. The vehicle of claim 15, wherein the first image sensor and the second image sensor are camera sensors.

17. The vehicle of claim 15, wherein the first image sensor and the second image sensor are radio detection and ranging (RADAR) sensors, or the first image sensor and the second image sensor are light detection and ranging (LiDAR) sensors.

18. The vehicle of claim 15, wherein the first ECU is further configured to verify the object detection performed using the first set of pixels matches with the object detection performed using the second set of pixels by the second ECU; and the second ECU is further configured to verify the object detection performed using the second set of pixels matches with the object detection performed using the first set of pixels by the first ECU.

19. The vehicle of claim 18, wherein the instructions further cause each of the first ECU and the second ECU to upon the object detection performed using the first set of pixels not matching with the object detection performed using the second set of pixels by the second ECU, calibrate the perception system by re-identifying the first set of pixels in the first field of view having common features with the second set of pixels in the second field of view.

20. The vehicle of claim 18, wherein the first set of pixels and the second set of pixels include one or more lane identification markers.
